(19) United States
(12) Patent Application Publication
(10) Pub. No.: US 2026/0188835 A1
(43) Pub. Date: Jul. 2, 2026

(54) SECONDARY BATTERY AND METHOD FOR MANUFACTURING THE SAME

(71) Applicant: SAMSUNG SDI CO., LTD., Yongin-si (KR)

(72) Inventor: Inseop BYUN, Yongin-si (KR)

(21) Appl. No.: 19/408,630

(22) Filed: Dec. 4, 2025

(30) Foreign Application Priority Data
Dec. 31, 2024 (KR) 10-2024-0202565

(51) Int. Cl. H01M 50/375; H01M 10/04; H01M 10/052; H01M 50/105; H01M 50/126; H01M 50/178; H01M 50/342; H01M 50/55

(52) U.S. Cl. CPC H01M 50/375; H01M 10/049; H01M 10/052; H01M 50/105; H01M 50/126; H01M 50/178; H01M 50/3425; H01M 50/55

(57) ABSTRACT

The present disclosure is to provide a secondary battery and a method for manufacturing the secondary battery. The secondary battery according to the present disclosure includes an electrode assembly having at least one electrode terminal, a case accommodating the electrode assembly, wherein the electrode terminal is outside of the case, and a film covering the electrode terminal, wherein the case includes a first outermost layer forming an outer surface of the case, a first innermost layer in contact with the film, and a first intermediate layer between the first outermost layer and the first innermost layer, wherein a melting point of the first innermost layer and the film is less than or equal to 130 degrees Celsius.

### CROSS-REFERENCE TO RELATED APPLICATION

This application claims priority under 35 U.S.C. § 119 to Korean Patent Application No. 10-2024-0202565, filed in the Korean Intellectual Property Office on Dec. 31, 2024, the entire contents of which are hereby incorporated by reference.

### BACKGROUND

### 1. Field

The present disclosure relates to a secondary battery and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

One type of secondary battery is a lithium-ion secondary battery. When a lithium-ion secondary battery is left or used at high temperatures for an extended period of time, or is charged or discharged with a high current, internal gas may be generated due to cell deterioration or the like. The internal gas generated in the lithium-ion secondary battery may further deteriorate cell performance. Furthermore, there may be a risk of ignition as the internal pressure of the case increases due to the internal gas, deforming the external appearance of the cell or damaging the internal electrode assembly.

In some types of secondary batteries, a vent component may be placed inside to avoid this problem. The vent component may function by discharging the gas generated inside to the outside when the case reaches a certain pressure. However, in some other types of secondary batteries, it may be difficult to adopt such a vent component due to material or structural limitations.

In this regard, there are various efforts to suppress the generation of internal gas in a secondary battery, quickly detect the generation of internal gas, and/or safely and efficiently discharge the internal gas.

The above information disclosed in this Background section is for enhancement of understanding of the background of the present disclosure, and therefore, it may contain information that does not constitute related (or prior) art.

### SUMMARY

One or more embodiments of the present disclosure are directed to a secondary battery and a method for manufacturing the secondary battery to address the above technical problem.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

A secondary battery according to an embodiment of the present disclosure for solving the technical problem includes an electrode assembly having at least one electrode terminal, a case accommodating the electrode assembly, wherein the electrode terminal is outside of the case, and a film covering the electrode terminal, wherein the case includes a first outermost layer forming an outer surface of the case, a first innermost layer in contact with the film, and a first intermediate layer between the first outermost layer and the first innermost layer, where a melting point of the first innermost layer and the film is less than or equal to 130 degrees Celsius.

According to an embodiment, the film may include a second outermost layer in contact with the case, a second innermost layer in contact with the terminal, and a second intermediate layer between the second outermost layer and the second innermost layer.

According to an embodiment, melting points of respectively the second outermost layer and the second innermost layer may be lower than a melting point of the second intermediate layer.

According to an embodiment, the melting point of at least one of the second outermost layer and the second innermost layer may be less than or equal to 125 degrees Celsius.

According to an embodiment, the melting point of the first innermost layer may be lower than a melting point of the first outermost layer and the first intermediate layer.

According to an embodiment, the melting point of the first innermost layer may be less than or equal to 125 degrees Celsius.

According to an embodiment, a vent flow path connected from an inside of the case to an outside of the case may be formed between the electrode terminals based on melting of the first innermost layer.

According to an embodiment, a vent flow path connected from an inside of the case to an outside of the case may be formed around the electrode terminal based on melting of at least one of the second outermost layer and the second innermost layer.

According to an embodiment, the first innermost layer and the second outermost layer may include Chlorinated polypropylene (CPP).

According to an embodiment, the secondary battery further may include a first adhesive layer between the first outermost layer and the first intermediate layer, and between the first intermediate layer and the first innermost layer.

According to an embodiment, the second innermost layer may include an adhesive.

According to an embodiment, the first adhesive layer and the second innermost layer may include a polyurethane-based material or a polyolefin-based material.

A method for manufacturing a secondary battery according to another embodiment of the present disclosure includes fabricating an electrode assembly having at least one electrode terminal, covering the electrode terminal with a film, inserting the electrode assembly into a case including a first innermost layer, a first outermost layer, and a first intermediate layer such that the electrode terminal is outside of the case, and coupling the film and the case, wherein in coupling the film and the case, the film and the first innermost layer are melted, wherein a melting point of the first innermost layer and the film is less than or equal to 130 degrees Celsius.

According to an embodiment, the film may include a second outermost layer in contact with the case, a second innermost layer in contact with the terminal, and a second intermediate layer between the second outermost layer and the second innermost layer.

According to an embodiment, melting points of respectively the second outermost layer and the second innermost layer may be lower than a melting point of the second intermediate layer.

According to an embodiment, a melting point of at least one of the second outermost layer and the second innermost layer may be less than or equal to 125 degrees Celsius.

According to an embodiment, a melting point of the first innermost layer may be lower than a melting point of the first outermost layer and the first intermediate layer.

According to an embodiment, the melting point of the first innermost layer may be less than or equal to 125 degrees (Celsius).

According to an embodiment, the first innermost layer and the second outermost layer may include Chlorinated polypropylene (CPP).

According to an embodiment, coupling the film and the case may further include coupling the film and the case by a heating sealing bar positioned at a position where the film and the first innermost layer of the case meet.

According to an embodiment of the present disclosure, it is possible to provide a secondary battery in which internal gas can be discharged (e.g., easily discharged) and a film for covering an electrode terminal of the secondary battery.

According to an embodiment of the present disclosure, it is possible to provide a film in which a case of a secondary battery and some layers contacting the case melt when an internal or external temperature of the secondary battery rises to a predetermined or set temperature value or higher, and a secondary battery including the same.

According to an embodiment of the present disclosure, it is possible to prevent or reduce explosion and ignition of a secondary battery in advance by allowing the seal between the case of the secondary battery and the electrode terminal to be released (e.g., quickly released) in a dangerous situation.

According to an embodiment of the present disclosure, it is possible to prevent an internal short circuit between the electrode terminals of the secondary battery by preventing a rapid increase in internal pressure and the resulting deformation of the components of the secondary battery.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is an exploded perspective view of a partially disassembled secondary battery according to an embodiment of the present disclosure.

FIG. 2 is a plan view of a secondary battery according to an embodiment of the present disclosure.

FIG. 3 is a cross-sectional view of the secondary battery of FIG. 2, taken along line X-X′.

FIG. 4 is a plan view of an electrode terminal and a terminal covering film according to an embodiment of the present disclosure.

FIG. 5 is a cross-sectional view of a case according to an embodiment of the present disclosure.

FIG. 6 is a cross-sectional view of the secondary battery of FIG. 2, taken along line Y-Y′.

FIG. 7 depicts a part of a first innermost layer and a terminal covering film of the secondary battery of FIG. 2 in a melted state, and gas inside the case being discharged to the outside.

FIG. 8 depicts a part of a first innermost layer and a terminal covering film in a melted state in the cross-sectional view of the secondary battery of FIG. 6, and gas inside the case being discharged to the outside.

FIG. 9 is a conceptual diagram of a process of sealing a secondary battery with a case and a terminal covering film according to an embodiment of the present disclosure.

FIG. 10 is a flowchart of a method for manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure, and are not intended to limit the present disclosure.

In the present disclosure, the sizes and relative sizes of layers and regions shown in the drawings may be exaggerated for clarity of description. That is, the sizes shown in the drawings are for convenience of understanding and are not limited thereto. In addition, the same reference numerals refer to the same components throughout the specification.

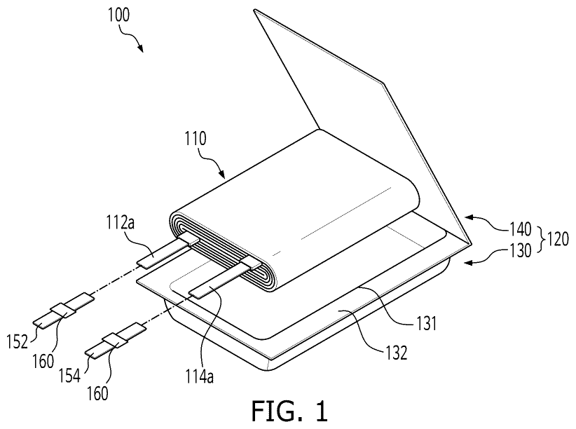

FIG. 1 is an exploded perspective view of a partially disassembled secondary battery according to an embodiment of the present disclosure.

A secondary battery 100 according to this embodiment may include an electrode assembly 110 and a case 120 that accommodates the electrode assembly 110 therein.

The electrode assembly 110 may be formed by winding a first electrode plate and a second electrode plate with a separator interposed therebetween. However, the present disclosure is not limited thereto, and the electrode assembly 110 may be formed in a structure in which a plurality of sheets of positive electrodes and negative electrodes are alternately stacked with a separator interposed therebetween.

A positive electrode for a lithium secondary battery may include a current collector and a positive electrode active material layer formed on the current collector. The positive electrode active material layer includes a positive electrode active material, and may further include a binder and/or a conductive agent.

As an example, the positive electrode may further include an additive that can serve as a sacrificial anode.

The content of the positive electrode active material may be 90% to 99.5% by weight based on 100% by weight of the positive electrode active material layer, and the content of the binder and the conductive agent may be 0.5% to 5% by weight each, based on 100% by weight of the positive electrode active material layer.

The binder may serve to adhere the positive electrode active material particles to each other, and also to adhere the positive electrode active material to the current collector. Representative examples of the binder include polyvinyl alcohol, carboxymethyl cellulose, hydroxypropyl cellulose, diacetyl cellulose, polyvinyl chloride, carboxylated polyvinyl chloride, polyvinyl fluoride, polymers including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, nylon, and the like, but are not limited thereto.

The conductive agent is used to impart conductivity to the electrode, and any electron conductive material can be used as long as it does not cause a chemical change in the battery to be configured. Examples of the conductive agent include carbon-based materials such as natural graphite, artificial graphite, carbon black, acetylene black, Ketjen black, carbon fiber, carbon nanofiber, and carbon nanotube; metal-based materials containing copper, nickel, aluminum, silver, etc., in the form of metal powder or metal fiber; conductive polymers such as polyphenylene derivatives; or mixtures thereof.

As the current collector, aluminum (Al) may be used, but it is not limited thereto.

As the separator, polyethylene, polypropylene, polyvinylidene fluoride, or a multilayer film of two or more layers thereof may be used, and in some embodiments a mixed multilayer film such as a polyethylene/polypropylene 2-layer separator, a polyethylene/polypropylene/polyethylene 3-layer separator, a polypropylene/polyethylene/polypropylene 3-layer separator, and the like may be used.

A negative electrode for a lithium secondary battery includes a current collector and a negative electrode active material layer located on the current collector. The negative electrode active material layer includes a negative electrode active material, and may further include a binder and/or a conductive agent.

For example, the negative electrode active material layer may include 90% to 99% by weight of a negative electrode active material, 0.5% to 5% by weight of a binder, and 0% to 5% by weight of a conductive agent.

The binder serves to adhere the negative electrode active material particles to each other, and also to adhere the negative electrode active material to the current collector. As the binder, a non-aqueous binder, an aqueous binder, a dry binder, or a combination thereof may be used.

Examples of the non-aqueous binder include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide-imide, polyimide, or a combination thereof.

The aqueous binder may be one selected from styrene-butadiene rubber, (meth)acrylated styrene-butadiene rubber, (meth)acrylonitrile-butadiene rubber, (meth)acrylic rubber, butyl rubber, fluoro rubber, polyethylene oxide, polyvinylpyrrolidone, polyepichlorohydrin, polyphosphazene, poly(meth)acrylonitrile, ethylene propylene diene copolymer, polyvinylpyridine, chlorosulfonated polyethylene, latex, polyester resin, (meth)acrylic resin, phenol resin, epoxy resin, polyvinyl alcohol, and combinations thereof.

When an aqueous binder is used as the negative electrode binder, it may further include a cellulose-based compound that can impart viscosity. As the cellulose-based compound, one or more of carboxymethyl cellulose, hydroxypropylmethyl cellulose, methyl cellulose, or alkali metal salts thereof may be mixed and used. As the alkali metal, sodium (Na), potassium (K), or lithium (Li) may be used.

The dry binder is a polymer material capable of fibrillation, and for example, it may be polytetrafluoroethylene, polyvinylidene fluoride, polyvinylidene fluoride-hexafluoropropylene copolymer, polyethylene oxide, or a combination thereof.

The conductive agent is used to impart conductivity to the electrode, and any electron conductive material can be used as long as it does not cause a chemical change in the battery to be configured. Specific examples include carbon-based materials such as natural graphite, artificial graphite, carbon black, acetylene black, Ketjen black, carbon fiber, carbon nanofiber, and carbon nanotube; metal-based materials including copper, nickel, aluminum, silver, etc., in the form of metal powder or metal fiber; conductive polymers such as polyphenylene derivatives; or mixtures thereof.

As the negative electrode current collector, one selected from copper foil, nickel foil, stainless steel foil, titanium foil, nickel foam, copper foam, a polymer substrate coated with a conductive metal, and combinations thereof may be used.

The separator may include a porous substrate, and a coating layer including an organic material, an inorganic material, or a combination thereof located on one or both sides of the porous substrate.

The porous substrate is a polymer film formed of any one polymer selected from polyolefins such as polyethylene and polypropylene, polyesters such as polyethylene terephthalate and polybutylene terephthalate, polyacetal, polyamide, polyimide, polycarbonate, polyetherketone, polyaryletherketone, polyetherimide, polyamide-imide, polybenzimidazole, polyethersulfone, polyphenylene oxide, cyclic olefin copolymer, polyphenylene sulfide, polyethylene naphthalate, glass fiber, Teflon, and polytetrafluoroethylene, or a copolymer or mixture of two or more of these.

The organic material may include a polyvinylidene fluoride-based polymer or a (meth)acrylic-based polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, but is not limited thereto.

The organic material and the inorganic material may exist mixed in one coating layer, or may exist in a laminated form of a coating layer including the organic material and a coating layer including the inorganic material.

The first electrode plate may be formed as a negative electrode plate, and the second electrode plate may be formed as a positive electrode plate, and in some embodiments, they may be formed in reverse. When the first electrode plate is formed as a negative electrode plate, it is formed by applying a negative electrode active material layer mainly composed of a carbon material to both sides of a negative electrode current collector made of a thin copper foil. A negative electrode uncoated portion, which is a region where the negative electrode active material layer is not coated, is formed at both ends of the negative electrode current collector.

The negative electrode active material includes a material capable of reversibly intercalating/deintercalating lithium ions, lithium metal, an alloy of lithium metal, a material capable of doping and dedoping lithium, or a transition metal oxide.

The material capable of reversibly intercalating/deintercalating lithium ions is a carbon-based negative electrode active material, and for example, may include crystalline carbon, amorphous carbon, or a combination thereof. Examples of the crystalline carbon include plate-like, flake, spherical, or fibrous natural graphite or artificial graphite, and examples of the amorphous carbon include soft carbon or hard carbon, mesophase pitch carbide, calcined coke, and the like. As the alloy of lithium metal, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As the material capable of doping and dedoping lithium, a Si-based negative electrode active material or a Sn-based negative electrode active material may be used. The Si-based negative electrode active material may be silicon, a silicon-carbon composite, SiOₓ (0<x<2), a Si-Q alloy (Q is selected from alkali metals, alkaline earth metals, group 13 elements, group 14 elements (excluding Si), group 15 elements, group 16 elements, transition metals, rare earth elements, and combinations thereof), or a combination thereof. The Sn-based negative electrode active material may be Sn, SnO₂, a Sn-based alloy, or a combination thereof.

The silicon-carbon composite may be a composite of silicon and amorphous carbon. According to one embodiment, the silicon-carbon composite may be in the form of silicon particles and amorphous carbon coated on the surface of the silicon particles. For example, it may include a secondary particle (core) in which silicon primary particles are assembled and an amorphous carbon coating layer (shell) located on the surface of the secondary particle. The amorphous carbon may also be located between the silicon primary particles, for example, the silicon primary particles may be coated with amorphous carbon. The secondary particles may be dispersed and exist in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

The Si-based negative electrode active material or the Sn-based negative electrode active material may be used in a mixture with a carbon-based negative electrode active material.

When the second electrode plate is formed as a positive electrode plate, it may be formed by applying a positive electrode active material layer mainly composed of a lithium-based oxide to both sides of a positive electrode current collector formed of a thin aluminum foil. A positive electrode uncoated portion, which is a region where the positive electrode active material layer is not coated, is formed at both ends of the positive electrode current collector.

As the positive electrode active material, a compound capable of reversible intercalation and deintercalation of lithium (lithiated intercalation compound) may be used. In some embodiments, one or more complex oxides of lithium with a metal selected from cobalt, manganese, nickel, and combinations thereof may be used.

The complex oxide may be a lithium transition metal complex oxide, and specific examples include a lithium nickel-based oxide, a lithium cobalt-based oxide, a lithium manganese-based oxide, a lithium iron phosphate-based compound, a cobalt-free nickel-manganese-based oxide, or a combination thereof.

As one example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L1_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the chemical formula, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

As one example, the positive electrode active material may be a high-nickel-based positive electrode active material in which the content of nickel is greater than or equal to 80 mol %, greater than or equal to 85 mol %, greater than or equal to 90 mol %, greater than or equal to 91 mol %, or greater than or equal to 94 mol %, and less than or equal to 99 mol %, with respect to 100 mol % of the metal excluding lithium in the lithium transition metal complex oxide. The high-nickel-based positive electrode active material can realize high capacity and can be applied to high-capacity, high-density lithium secondary batteries.

In the electrode assembly 110, a first electrode tab 112a may be formed on one side of the first electrode plate, and a second electrode tab 114a may be formed on one side of the second electrode plate. The first electrode tab 112a and the second electrode tab 114a may be formed by welding tabs to the uncoated portions of the first electrode plate and the second electrode plate, or may be formed by punching the uncoated portions of the first electrode plate and the second electrode plate. In some embodiments, in a wound state, the first electrode tab 112a and the second electrode tab 114a are arranged in parallel with a constant interval. When the first electrode plate is formed as a negative electrode plate, the first electrode tab 112a is formed as a negative electrode tab, and the second electrode tab 114a may be formed as a positive electrode tab. When the polarities of the first electrode plate and the second electrode plate are reversed, in some embodiments, the first electrode tab 112a is formed as a positive electrode tab, and the second electrode tab 114a may be formed as a negative electrode tab.

The first electrode tab 112a and the second electrode tab 114a may be coupled with a first electrode terminal 152 and a second electrode terminal 154 so that the electrode assembly 110 is electrically connected to the outside of the case 120. A part of the electrode terminals 152 and 154 is formed to be exposed to the outside of the case 120. Hereinafter, when it is necessary to refer to both the first electrode tab 112a and the second electrode tab 114a, they will be referred to as electrode tabs 112a and 114a, and when it is necessary to refer to both the first electrode terminal 152 and the second electrode terminal 154, they will be referred to as electrode terminals 152 and 154. The electrode tabs 112a and 114a and the electrode terminals 152 and 154 are generally formed of metal, usually aluminum, copper, or nickel, and are formed of a metal having a certain level of electrical conductivity or higher to minimize voltage drop.

In some embodiments, the electrode terminals 152 and 154 are each formed to include a film (referred to as a terminal covering film) 160 located on one or both of their upper and lower surfaces. In some embodiments, the electrode terminals 152 and 154 are formed to include the terminal covering film 160 attached to a portion that contacts a sealing portion of an edge of the case 120.

The case 120 forms the overall appearance of the secondary battery 100, and may be formed of a conductive metal such as aluminum, an aluminum alloy, or nickel-plated steel. The case 120 may provide a space for accommodating the electrode assembly. According to an embodiment, the case 120 may be a pouch-type case, and the secondary battery 100 may be a pouch-type secondary battery. However, the scope of the present disclosure is not limited thereto, and the secondary battery 100 may be a battery cell of any shape such as prismatic, cylindrical, etc.

The case 120 according to an embodiment of the present disclosure is formed to include an upper case 140 and a lower case 130, which are formed by folding a generally integrally formed approximately rectangular case film in the middle based on the length direction of one side. In a substantially central region of the lower case 130, an accommodation portion 131 for accommodating the electrode assembly 110 is formed by press processing or the like. An extension portion 132 is formed in four directions on the upper edge of the accommodation portion 131.

The lower case 130 may be coupled with an open one end of the upper case 140 to seal the upper case 140. According to an embodiment, one surface of the lower case 130 may be opened, and the upper case 140 may seal the opened one surface of the lower case 130.

In an embodiment, the case 120 may include an electrolyte injection port (not shown). For example, the electrolyte injection port may be a through-hole formed in the case 120. After the upper case 140 is coupled to the opening of the lower case 130 and sealed, the electrolyte injection port may be formed to inject an electrolyte into the case 120. The electrolyte injection port may be sealed with a sealing member after the electrolyte is injected.

The secondary battery 100 may be a lithium battery cell (e.g., a lithium-ion battery cell), a sodium battery cell, etc. However, the scope of the present disclosure is not limited thereto, and the secondary battery 100 includes all batteries that can repeatedly provide electricity by charging and discharging.

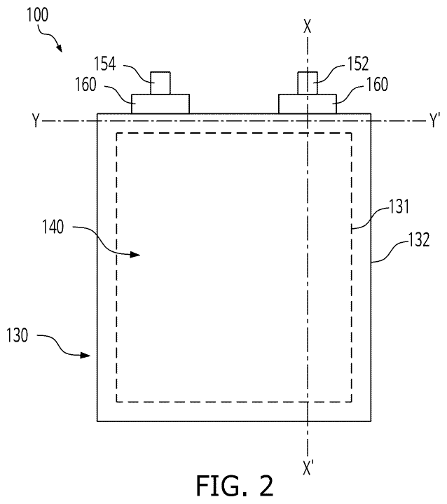

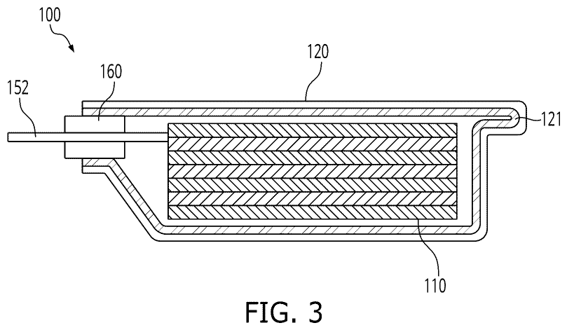

FIG. 2 is a plan view of a secondary battery according to an embodiment of the present disclosure. FIG. 3 is a cross-sectional view of the secondary battery of FIG. 2, taken along line X-X′.

According to an embodiment, the secondary battery shown in FIG. 2 and FIG. 3 may be substantially the same as the one in which the components of the secondary battery shown in FIG. 1 are assembled. The electrode assembly 110 is disposed or placed in the accommodation portion 131 of the sealed case 120.

The extension portion 132 of the lower case 130 is a remaining part after forming the accommodation portion 131 by press processing the lower case 130, and is formed in a shape extending in a direction away from the accommodation portion 131. The extension portion 132 may be sealed by being thermally compressed with an edge portion of the upper case 140 after the electrode assembly 110 is accommodated in the accommodation portion 131.

At least a part of the electrode terminals 152 and 154 may protrude to the outside of the case 120. For example, as shown in FIG. 2, at least a part of the electrode terminals 152 and 154 may protrude from an upper end of the case 120 along an upward direction.

The extension portion 132 may include a sealing surface formed to extend in a direction in which the electrode terminals 152 and 154 are drawn out. The sealing surface may correspond to an upper region of the extension portion 132. The sealing surface may contact the terminal covering film 160 surrounding the electrode terminals 152 and 154 during sealing of the upper case 140 and the lower case 130.

According to an embodiment, at least a part of the terminal covering film 160 may protrude to the outside of the case 120. For example, as shown in FIG. 2, at least a part of the terminal covering film 160 may protrude from the upper end of the case 120 along the upward direction. However, the present disclosure is not limited thereto, and for example, the terminal covering film 160 may not be exposed to the outside of the case 120.

In an embodiment, the terminal covering film 160 may be disposed or arranged to be in contact with the sealing surface of the case 120. Referring to FIG. 3, a length of the terminal covering film 160 in a drawing-out direction of the electrode terminals 152 and 154 (left-right direction in FIG. 3) may be equal to or greater than a length of the sealing surface of the case 120 in the drawing-out direction. Along the drawing-out direction, a distance between an outer end and an inner end of the electrode terminals 152 and 154 may be equal to or greater than a distance between an outer end and an inner end of the extension portion 132.

According to an embodiment, an outer end of the terminal covering film 160 may be disposed or arranged outwardly beyond the outer end of the sealing surface. An inner end of the terminal covering film 160 may be disposed inwardly beyond an inner end of the sealing surface. According to some embodiments, the outer end of the terminal covering film 160 is disposed or arranged at the same position as the outer end of the sealing surface, and the inner end of the terminal covering film 160 may be disposed inwardly beyond the inner end of the sealing surface. According to some embodiments, the outer end of the terminal covering film 160 is disposed or arranged inwardly beyond the outer end of the sealing surface, and the inner end of the terminal covering film 160 may be disposed or arranged at the same position as the inner end of the sealing surface. According to some embodiments, the outer end of the terminal covering film 160 is disposed or arranged at the same position as the outer end of the sealing surface, and the inner end of the terminal covering film 160 may be disposed or arranged at the same position as the inner end of the sealing surface.

According to an embodiment, during sealing of the upper case 140 and the lower case 130, the sealing may be performed at a temperature of approximately 180 degrees Celsius to approximately 220 degrees Celsius. The processing temperature at which the sealing is performed may be higher than a melting point of the terminal covering film 160. The time during which heat is applied to the case 120 for sealing may correspond to approximately 2 to 3 seconds. By applying heat for such a relatively short time, it is possible to prevent or reduce melting of the terminal covering film during sealing.

A terminal covering film 160 according to an embodiment of the present disclosure may have a shape and size corresponding to an area of a portion where the electrode terminals 152 and 154 and the case 120 contact. Under a normal state where the secondary battery 100 operates normally (e.g., the battery is not overheating), the terminal covering film 160 may form a seal between the electrode terminals 152 and 154 and the case 120. The terminal covering film 160 may prevent or reduce the entering of foreign substances to the inside of the secondary battery 100 from the outside.

In some embodiments, under a specific state or specific environmental conditions that are not a normal state, the secondary battery 100 may operate abnormally and the electrode terminals 152 and 154 may overheat. In this case, at least a part of the terminal covering film 160 may be melted by heat generated from the electrode terminals 152 and 154 or from inside the secondary battery case. As at least a part of the terminal covering film 160 may melt, a gap or a vent flow path may be formed between the case 120 and the electrode terminals 152 and 154. The gap or the vent flow path may allow gas generated inside the secondary battery 100 to escape to the outside of the case. In some embodiments, the terminal covering film 160 may act like a safety vent in a sealing area of the case 120.

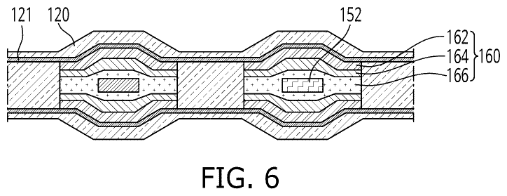

A thickness of the terminal covering film 160 (e.g., a distance in the up-down direction in FIG. 3) may be substantially the same as a separation distance between the electrode terminals 152 and 154 and the case 120. According to an embodiment, after the terminal covering film 160 is formed to be thicker than a gap between the electrode terminals 152 and 154 and the case 120, the thickness of the terminal covering film 160 may be partially reduced during a sealing process of the case 120. According to another embodiment, the terminal covering film 160 may be formed to be substantially the same as the gap between the electrode terminals 152 and 154 and the case 120 before the sealing process. A detailed configuration of the terminal covering film 160 will be described later in FIG. 6.

According to an embodiment, the electrode terminals 152 and 154 may have a larger amount of heat generation compared to other components of the secondary battery 100. The terminal covering film 160 may be formed to be in contact (e.g., in direct contact) with the electrode terminals 152 and 154, which have a relatively large amount of heat generation. With this configuration, it is possible for the terminal covering film 160 to respond relatively quickly to a temperature rise of the secondary battery 100 compared to a film formed at another location.

According to an embodiment, the case 120 may include a case film for preventing or reducing damage to an outer surface or for insulation from the outside. The case film may be formed on an outermost layer of the case 120, and may include a metal thin film, an insulating resin, a heat-adhesive synthetic resin, or the like. A base material (or innermost layer) of the case 120 may contact the terminal covering film 160. The base material of the case 120 may include a material of the same or a similar series as the terminal covering film 160. With this configuration, the adhesion force between the terminal covering film 160 located in the sealing portion and the base material of the case 120 may be increased during sealing of the case 120.

Referring to FIG. 2, the terminal covering film 160 is formed on both the first electrode terminal 152 and the second electrode terminal 154. However, the present disclosure is not limited thereto. For example, the present disclosure may also include an embodiment in which the terminal covering film is formed only on either one of the first electrode terminal 152 and the second electrode terminal 154. According to an embodiment, the terminal covering film 160 may be formed only on a positive electrode terminal, which has a relatively large amount of heat generation among the positive electrode terminal and the negative electrode terminal, and may not be formed on the negative electrode terminal.

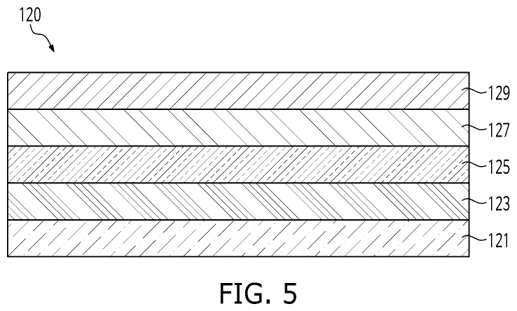

Referring to FIG. 3, the case 120 may include a first innermost layer 121. The first innermost layer 121 may be located on an innermost surface of the case 120. The first innermost layer 121 may be in contact with the terminal covering film 160. The first innermost layer 121 may be a low melting point layer (e.g., a melting point layer below a threshold). At least a part of the first innermost layer 121 may melt when the secondary battery 100 operates abnormally and overheats. As at least a part of the first innermost layer 121 melts, a gap or a vent flow path may be formed between the case 120 and the electrode terminals 152 and 154. The gap or the vent flow path serves to allow gas generated inside the secondary battery 100 to escape to the outside. A melting point of the terminal covering film 160 and the first innermost layer 121 may be less than or equal to 130 degrees Celsius. In some embodiments, the melting point of the terminal covering film 160 and the first innermost layer 121 may be less than or equal to 125 degrees Celsius. The terminal covering film 160 and the first innermost layer 121 may melt at a low temperature (e.g., a temperature below a threshold) to widen or increase a melting point range, so that a larger vent flow path can be formed in a short time. A detailed configuration of the case 120 will be described later in FIG. 5 and FIG. 6.

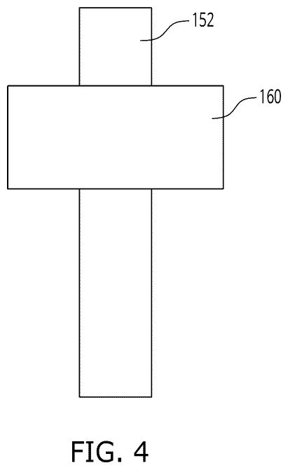

FIG. 4 is a plan view of an electrode terminal and a terminal covering film according to an embodiment of the present disclosure.

Referring to FIG. 4, the terminal covering film 160 may cover the electrode terminal 152. The terminal covering film 160 may include a plurality of layers. A description of the plurality of layers of the terminal covering film 160 will be described later in FIG. 6.

The terminal covering film 160 may have a shape similar to a rectangular parallelepiped with rounded corners. However, the present disclosure is not limited thereto. For example, the shape of the terminal covering film 160 shown in the plan view of FIG. 4 may have various shapes such as a circle, a semicircle, an inverted triangle, a polygon, and the like.

FIG. 4 illustrates one terminal covering film 160. However, this is only for convenience of description, and the present disclosure is not limited thereto. A secondary battery 100 according to the present disclosure may include two terminal covering films 160 that are in contact with two electrode terminals 152 and 154, respectively. According to an embodiment, the terminal covering film 160 in contact with the first electrode terminal 152 may be different from the terminal covering film 160 in contact with the second electrode terminal 154 in at least one of shape, length, thickness, cross-sectional shape, and material.

FIG. 5 is a cross-sectional view of a case according to an embodiment of the present disclosure.

The case 120 may include a first innermost layer 121, a first intermediate layer 125, and a first outermost layer 129. The first innermost layer 121 may be an inner surface of the case 120. The first innermost layer 121 may be in contact with the electrode terminal film. The first innermost layer 121 may correspond to a low melting point layer. A melting point of the first innermost layer 121 may be less than or equal to 125 degrees (Celsius). When the temperature of the secondary battery 100 rises, the first innermost layer 121 may melt at less than or equal to 125 degrees Celsius. Based on the first innermost layer 121 melting at less than or equal to 125 degrees Celsius, the first innermost layer can form a vent flow path that can discharge the gas inside the secondary battery 100 to the outside at a lower temperature than in the prior art. The first innermost layer 121 may include Chlorinated polypropylene (CPP). A thickness of the first innermost layer 121 may be in a range from approximately 35 μm to approximately 45 μm.

The first intermediate layer 125 may include a metal foil layer. The first intermediate layer 125 may be disposed or arranged between the first innermost layer 121 and the first outermost layer 129. The first intermediate layer 125 may serve to prevent moisture and oxygen from entering from the outside and to prevent the electrolyte filled inside the case 120 from leaking to the outside. The first intermediate layer 125 may serve to maintain the mechanical strength of the case 120. The first intermediate layer 125 may be formed of aluminum, stainless steel, copper, or an equivalent thereof. A melting point of the first intermediate layer 125 may be higher than the melting point of the first innermost layer 121. A thickness of the first intermediate layer 125 may be in a range from approximately 35 μm to approximately 45 μm.

The first outermost layer 129 may be an outer surface of the case 120. The first outermost layer 129 may serve to mitigate mechanical and chemical shocks with external electronic devices. The first outermost layer 129 may be formed of any one selected from nylon, polyethylene terephthalate (PET), polybutylene terephthalate (PBT), polybutylene naphthalate (PBN), and equivalents thereof, but the present disclosure is not limited thereto. A melting point of the first outermost layer 129 may be higher than the melting point of the first innermost layer 121. A thickness of the first outermost layer 129 may be in a range from approximately 20 μm to approximately 40 μm.

An adhesive layer 123 and 127 may be included between the first innermost layer 121 and the first intermediate layer 125, and between the first intermediate layer 125 and the first outermost layer 129, respectively. The first innermost layer 121 and the first intermediate layer 125 may be adhered by the adhesive layer 123. The first intermediate layer 125 and the first outermost layer 129 may be adhered by the adhesive layer 127. The adhesive layers 123 and 127 may include a polyurethane-based material or a polyolefin-based material. A thickness of the adhesive layers 123 and 127 may be in a range from approximately 1 μm to approximately 5 μm.

FIG. 6 is a cross-sectional view of the secondary battery of FIG. 2, taken along line Y-Y′.

A case 120 and a terminal covering film 160 according to the present disclosure may include a plurality of layers. Referring to FIG. 6, the case 120 may include a first innermost layer 121. The first innermost layer 121 may be a low melting point layer, and its melting point may be less than or equal to 125 degrees (Celsius).

The terminal covering film 160 may include a second outermost layer 162 that contacts the first innermost layer 121 of the case 120, a second intermediate layer 164 disposed or arranged between the second outermost layer 162 and a second innermost layer 166, and the second innermost layer 166 that contacts the electrode terminal 152.

The second outermost layer 162 may be a configuration for sealing the terminal covering film 160. The second outermost layer 162 may include Chlorinated polypropylene (CPP). A melting point of the second outermost layer 162 may be less than or equal to 125 degrees (Celsius).

The second innermost layer 166 may be a configuration for covering and adhering the terminal covering film 160 to the electrode terminal. The second innermost layer 166 may include an adhesive. The second innermost layer 166 may include a polyurethane-based material or a polyolefin-based material. A melting point of the second innermost layer 166 may be less than or equal to 125 degrees (Celsius).

The second intermediate layer 164 may be a heat resistant layer. According to an embodiment, melting points of the second outermost layer 162 and the second innermost layer 166 may be lower than a melting point of the second intermediate layer 164. As described above, the secondary battery or the electrode terminal 152 may overheat. At least one of the second outermost layer 162 and the second innermost layer 166, which have a relatively low melting point, may at least partially melt at a point in time earlier than a point in time when the second intermediate layer 164 melts. As a result, a fine gap or a vent flow path may be formed between the case 120 and the electrode terminal 152, and through this, gas generated inside the case 120 may be discharged to the outside of the case 120.

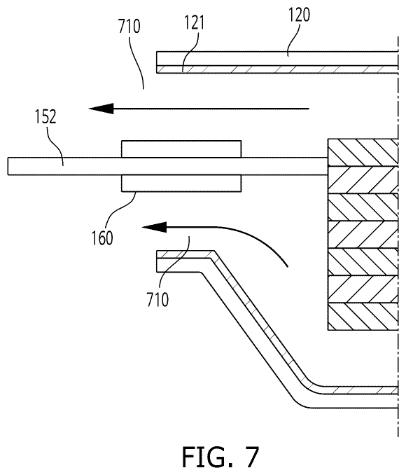

FIG. 7 depicts a part of the first outermost layer and the terminal covering film of the secondary battery of FIG. 2 in a melted state, and gas inside the case being discharged to the outside.

At least one of a first innermost layer 121 and a terminal covering film 160 according to the present disclosure may melt at a predetermined or set temperature. As described above, a secondary battery or an electrode terminal 152 may overheat. As at least a part of the first innermost layer 121 and the terminal covering film 160 melt at a melting point, a vent flow path 710 may be formed between a case 120 and electrode terminals 152 and 154. The vent flow path 710 may be formed around the electrode terminals 152 and 154. The vent flow path 710 may allow gas generated inside a secondary battery 100 to escape to the outside of the case 120.

According to an embodiment, a part of the first innermost layer 121 and the terminal covering film 160 may be melted. In some embodiments, a part of either the first innermost layer 121 or the terminal covering film 160 may be melted. For example, if both a part of the first innermost layer 121 and a part of the terminal covering film 160 are melted, the vent flow path 710 may form a wider space than in the prior art. For example, the first innermost layer 121 and a second outermost layer 162 of the terminal covering film 160 may melt to secure a relatively wide space for the vent flow path 710, so that internal gas can be discharged (e.g., quickly discharged) to prevent ignition of the secondary battery.

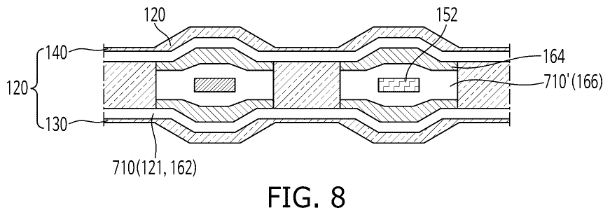

FIG. 8 depicts a part of the first innermost layer and the terminal covering film in a melted state in the cross-sectional view of the secondary battery of FIG. 6, and gas inside the case being discharged to the outside of the case 120.

A part of a first innermost layer 121 and a terminal covering film 160 according to the present disclosure can have at least one component melt at a predetermined or set temperature. As described above, a secondary battery or an electrode terminal 152 may overheat. As at least a part of the first innermost layer 121 and the terminal covering film 160 melt at a melting point, a vent flow path 710 and 710′ may be formed between a case 120 and electrode terminals 152 and 154. For example, the first innermost layer 121 and a second outermost layer 162 may melt to form the vent flow path 710, and a second innermost layer 166 may melt to form a vent flow path 710′. The vent flow path 710 may allow gas generated inside a secondary battery 100 to escape to the outside of the case 120.

Referring to FIG. 8, the first innermost layer 121 may be formed along an inner surface of the case 120. As the first innermost layer 121 melts at a predetermined or set temperature, the vent flow path 710 may be formed. Based on the first innermost layer 121 melting, the vent flow path 710 may be formed between the contacting cases 120. As at least a part of the first innermost layer 121 and the second outermost layer 162 melt, the vent flow path 710 may be formed between a lower case 130 and an upper case 140. As the second innermost layer 166 melts at a predetermined or preset temperature, the vent flow path 710′ may be formed. Based on the second innermost layer 166 melting, the vent flow path 710′ may be formed around a terminal 152. The vent flow path 710 and 710′ of the present disclosure may form a wider space than in the prior art. By securing a wide space for the vent flow path 710 and 710′, internal gas may be discharged (e.g., quickly discharged) to prevent ignition of the secondary battery.

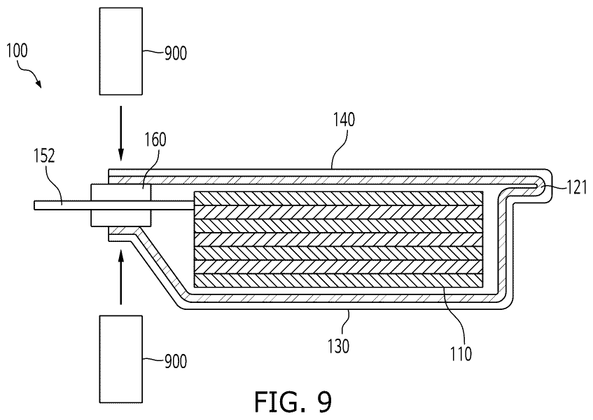

FIG. 9 is a conceptual diagram of a process of sealing a secondary battery with a case and a terminal covering film according to an embodiment of the present disclosure.

A case 120 may include a first innermost layer 121. An electrode terminal 152 may be wrapped by a terminal covering film 160. The terminal covering film 160 may include a second outermost layer and a second innermost layer.

The electrode terminal 152 coupled with the terminal covering film 160 may be disposed or arranged between an upper case 140 and a lower case 130, each including the first innermost layer 121. The terminal covering film 160 and the case 120 may be coupled. The terminal covering film 160 and the case 120 may be coupled by a heating sealing bar 900 at a position where the first innermost layer 121 of the case 120 and the terminal covering film 160 meet.

The heating sealing bar 900 may apply pressure and temperature to the upper case 140 and the lower case 130. The heating sealing bar 900 may melt and couple the first innermost layer 121 and the terminal covering film 160.

According to an embodiment, during coupling of the upper case 140 and the lower case 130, the coupling may be performed at a temperature of approximately 180 degrees (Celsius) to 220 degrees (Celsius). The processing temperature at which the coupling is performed may be higher than a melting point of the terminal covering film 160. The time during which heat is applied to the case 120 for coupling may be only about 2 to 3 seconds. By applying heat for such a relatively short time, it is possible to prevent the first innermost layer 121 and the terminal covering film 160 from melting during coupling.

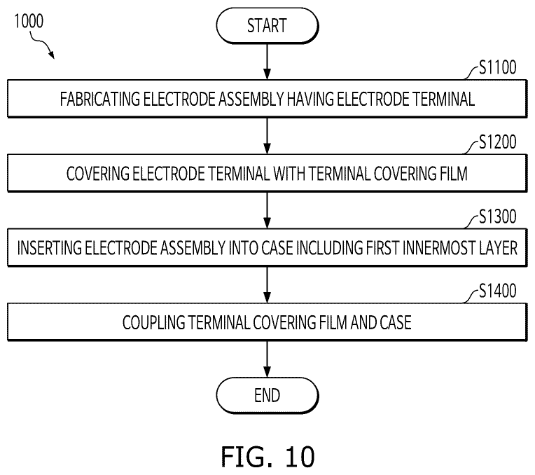

FIG. 10 is a flowchart of a method for manufacturing a secondary battery according to an embodiment of the present disclosure.

A method for manufacturing a secondary battery 1000 according to an embodiment of the present disclosure may be initiated by fabricating an electrode assembly having at least one electrode terminal (S1100).

The method may include a step of covering the electrode terminal with a terminal covering film (S1200). The terminal covering film may cover a part of the electrode terminal. The terminal covering film may include a second innermost layer, a second outermost layer, and a second intermediate layer. The second innermost layer and/or the second outermost layer may be configured to melt at less than or equal to 125 degrees Celsius or 130 degrees Celsius.

The electrode assembly including the electrode terminal covered by the terminal covering film may be inserted into a case (S1300) in such a way that the electrode terminal is drawn outside of the case. The case may include a first innermost layer, a first outermost layer, and a first intermediate layer. The first innermost layer may be configured to melt at less than or equal to 125 degrees Celsius or 130 degrees Celsius.

The terminal covering film and the case may be coupled (S1400). The terminal covering film and the case may be coupled by a heating sealing bar. The heating sealing bar may melt and couple the terminal covering film and the first innermost layer of the case. The heating sealing bar may apply pressure and temperature to a position where the terminal covering film and the first innermost layer of the case meet to couple them.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A secondary battery, comprising:
an electrode assembly having at least one electrode terminal;
a case accommodating the electrode assembly, wherein the electrode terminal is outside of the case; and
a film covering the electrode terminal,
wherein the case comprises:
a first outermost layer forming an outer surface of the case;
a first innermost layer in contact with the film; and
a first intermediate layer between the first outermost layer and the first innermost layer, wherein a melting point of the first innermost layer and the film is less than or equal to 130 degrees Celsius.

2. The secondary battery as claimed in claim 1, wherein the film comprises:
a second outermost layer in contact with the case;
a second innermost layer in contact with the terminal; and
a second intermediate layer between the second outermost layer and the second innermost layer.

3. The secondary battery as claimed in claim 2, wherein melting points of respectively the second outermost layer and the second innermost layer are lower than a melting point of the second intermediate layer.

4. The secondary battery as claimed in claim 3, wherein the melting point of at least one of the second outermost layer and the second innermost layer is less than or equal to 125 degrees Celsius.

5. The secondary battery as claimed in claim 4, wherein the melting point of the first innermost layer is lower than a melting point of the first outermost layer and the first intermediate layer.

6. The secondary battery as claimed in claim 5, wherein the melting point of the first innermost layer is less than or equal to 125 degrees Celsius.

7. The secondary battery as claimed in claim 6, a vent flow path connected from an inside of the case to an outside of the case is configured to be formed between the electrode terminals based on melting of the first innermost layer.

8. The secondary battery as claimed in claim 6, a vent flow path connected from an inside of the case to an outside of the case is configured to be formed around the electrode terminal based on melting of at least one of the second outermost layer and the second innermost layer.

9. The secondary battery as claimed in claim 2, wherein the first innermost layer and the second outermost layer comprise Chlorinated polypropylene (CPP).

10. The secondary battery as claimed in claim 2 further comprising an adhesive layer between the first outermost layer and the first intermediate layer, and between the first intermediate layer and the first innermost layer.

11. The secondary battery as claimed in claim 10, wherein the second innermost layer comprises an adhesive.

12. The secondary battery as claimed in claim 11, wherein the adhesive layer and the second innermost layer comprise a polyurethane-based material or a polyolefin-based material.

13. A method for manufacturing a secondary battery, comprising:
fabricating an electrode assembly having at least one electrode terminal;
covering the electrode terminal with a film;
inserting the electrode assembly into a case comprising a first innermost layer, a first outermost layer, and a first intermediate layer, wherein the electrode terminal is outside of the case; and
coupling the film and the case,
wherein in coupling the film and the case, the film and the first innermost layer are melted, wherein a melting point of the first innermost layer and the film is less than or equal to 130 degrees Celsius.

14. The method for manufacturing a secondary battery as claimed in claim 13, wherein the film comprises: a second outermost layer in contact with the case; a second innermost layer in contact with the terminal; and a second intermediate layer between the second outermost layer and the second innermost layer.

15. The method for manufacturing a secondary battery as claimed in claim 14, wherein melting points of respectively the second outermost layer and the second innermost layer are lower than a melting point of the second intermediate layer.

16. The method for manufacturing a secondary battery as claimed in claim 15, wherein the melting point of at least one of the second outermost layer and the second innermost layer is less than or equal to 125 degrees (Celsius).

17. The method for manufacturing a secondary battery as claimed in claim 16, wherein the melting point of the first innermost layer is lower than a melting point of the first outermost layer and the first intermediate layer.

18. The method for manufacturing a secondary battery as claimed in claim 17, wherein the melting point of the first innermost layer is less than or equal to 125 degrees Celsius.

19. The method for manufacturing a secondary battery as claimed in claim 18, wherein the first innermost layer and the second outermost layer comprise Chlorinated polypropylene (CPP).

20. The method for manufacturing a secondary battery as claimed in claim 13, wherein the coupling the film and the case further comprises coupling the film and the case by a heating sealing bar at a position where the film and the first innermost layer of the case meet.
